(19) United States
(12) Patent Application Publication
(10) Pub. No.: US 2006/0084384 A1
(43) Pub. Date: Apr. 20, 2006

(54) Mobile communications terminal, accessories and method therefore

(76) Inventor: Jarmo Kiemunki, Oulu (FI)

Correspondence Address: PERMAN & GREEN, 425 POST ROAD, FAIRFIELD, CT, 06824, US

(21) Appl. No.: 10/933,664

(22) Filed: Sep. 3, 2004

(51) Int. Cl. H04Q 7/20

(52) U.S. Cl. 455/41.3; 455/566; 455/575.2

(57) ABSTRACT

An accessory device for an electric device is disclosed. The accessory device including a control unit adapted to determine at least one parameter value related to a current operational status of the accessory device and for use by the electric device, and a transceiver connected to the control unit and adapted to transfer the at least one parameter value from the control unit in the accessory device to the electric device via a first wireless communication protocol.

### TECHNICAL FIELD

The present invention generally relates to wireless communication between different devices, and more specifically to methods, devices and system for providing a mobile telecommunication terminal with information relating to the status of an accessory device communicating with the mobile telecommunication terminal.

### TECHNICAL BACKGROUND

Mobile telecommunication terminals, such as mobile telephones, are widely used in everyday life of many people. The extensive use of mobile telecommunication terminals results in a demand for additional functionality of the terminals. The demand for additional functionality is normally met not by incorporating more features into the mobile terminal itself, but rather by providing accessory equipment that performs specific tasks not provided for in the mobile terminal.

For example, a person using a mobile telecommunication terminal in the form of a mobile telephone for many hours a day for talking to other people will find it awkward to be compelled to hold the mobile telephone in his hand during the telephone conversations. The solution to this problem is to provide an accessory device in the form of a handsfree unit which is connected to the mobile telephone so that the user can use both hands for performing other tasks while talking to other people over the phone.

The handsfree unit is preferably arranged in the vicinity of the user's mouth and at least one ear and may be connected to the mobile telecommunication terminal in many different ways. For many years the common way to connect a handsfree unit to a mobile telecommunication terminal has been by means of a cable running from the handsfree unit via a connector on the casing of the mobile telecommunication terminal to the electric circuitry in the mobile telecommunication terminal. The cable transfers audio data from a microphone arranged in the handsfree unit to the mobile telecommunication terminal, where it is normally processed in the same way as audio data otherwise received from the microphone in the mobile terminal itself. Correspondingly the cable also transfers audio data from the mobile telecommunication terminal to an earphone in the handsfree unit so that the user does not have to use the loudspeaker arranged in the mobile telecommunication terminal.

However, the use of a cable for connecting the handsfree unit to the mobile telecommunication terminal is afflicted with many drawbacks. For instance, the cable may break causing signal interruption or intermittent contact between the handsfree unit and the mobile telecommunication terminal. Moreover, the cable may get entangled in objects in the vicinity of the cable, e.g. a hand brake lever or gear lever when using the handsfree unit in a car.

Another approach to interconnect the handsfree unit with the mobile telecommunication terminal is to use wireless technology for transferring the audio data back and forth between the handsfree unit and the mobile telecommunication terminal. The de facto standard today for wireless transmission of audio data between a handsfree unit and a mobile telecommunication terminal is Bluetooth™ which uses the unlicensed ISM (Industrial, Scientific and Medical) band at 2400-2483.5 MHz. The problem of e.g. cable disruption between the handsfree unit and the mobile telecommunication terminal will hence be eliminated by the use of wireless technology, such as the Bluetooth™ protocol.

However, the electric circuits in a wireless handsfree unit need to be powered in order to be able to transfer audio data to and receive audio data from the mobile telecommunication terminal. To this end small, preferably rechargeable, batteries are arranged inside the handsfree unit providing the necessary power for operation of the handsfree unit. The capacity of the battery packs in handsfree units today using Bluetooth™ technology provides operation of the handsfree unit during approximately 4-10 hours talk time and 80-400 hours standby time.

Even though the expected operating time of the batteries in a handsfree unit is relatively long, the batteries need to be recharged or replaced after a specific period of time. Consequently, the handsfree unit may run out of power during a telephone conversation, disrupting the conversation and causing great annoyance for all parties to the conversation. Alternatively, the handsfree unit may run out of power during standby, making it inoperative when needed for making or receiving a telephone call.

In order to combat this problem, different solutions have been proposed in the art. One solution is to provide the handsfree unit with a control unit that continuously measures the power level in the batteries in the handsfree unit and alarms the user of the handsfree unit by emitting sound, e.g. beeps or clicks, once the battery level falls below a predetermined level. With this solution, even though the user of the handsfree unit will be alarmed when the battery level gets too low, he will not be able to determine the current battery status of the handsfree unit before the critical low power level has been reached. A user of a handsfree unit would benefit from being able to determine the current battery status of the handsfree unit e.g. when setting out for a longer journey or business trip.

Another solution is disclosed in U.S. 2002/0090099 A1. This document discloses a handsfree unit using Bluetooth™ for wireless communication with other devices in the proximity of the handsfree unit. In order for a user to be able to determine the current power level of the batteries in the handsfree unit, a display is arranged on the handsfree unit, on which the current power supply level and other operational status data such as a caller identification number and/or received signal strength are presented. Even though this solution eliminates some of the problems with indicating the current operational status of the handsfree unit it is not optimal in that the handsfree unit must be equipped with an additional display making the handsfree unit more complex, more expensive and also bulky due to the required physical size of the display, thereby making the handsfree unit uncomfortable to wear for longer periods of time.

Consequently, there is a need for an accessory device that is able to efficiently provide information relating to the operational status of the accessory device to the user of e.g. a mobile telecommunication terminal to which the accessory device is connected by means of a wireless communication protocol.

### SUMMARY OF THE INVENTION

An object of the present invention is to overcome the above described problems of the known technologies in regards to providing status information from the accessory device to e.g. the user of a mobile telecommunication terminal.

A particular advantage of the present invention is the provision of a simple and reliable way to provide information regarding the status of an accessory device to a user of a mobile telecommunication terminal without the need to equip the accessory device with a display. The above objects, advantages and features together with numerous other objects, advantages and features, which will become evident from the detailed description below, are obtained according to a first aspect of the present invention by an accessory device for an electric device, the accessory device comprising:

a control unit adapted to determine at least one parameter value related to the current operational status of the accessory device and for use by the electric device; and

a transceiver connected to the control unit and adapted to transfer the at least one parameter value from the control unit in the accessory device to the electric device via a first wireless communication protocol.

The accessory device will hence be able to report its current operational status to another device. The other device, comprising a display, may then display the current status of the accessory device, wherein no means for displaying is needed in the accessory device. The accessory device hence becomes simpler in construction and less expensive to manufacture.

The accessory device may communicate via a wireless communication protocol in the form of a short range communication protocol, such as Bluetooth, WLAN, HomeRF or IrDA.

The accessory device will then minimize the risk of information tapping by third parties via the wireless communication link and at the same time minimize the interference with other devices outside the range of the short range wireless communication link.

The accessory device may comprise a battery for providing power to the accessory device, wherein the at least one transferred parameter value is related to the current power level of the battery.

The accessory device will hence be able to report its estimated remaining operational time, making it possible to avoid unnecessary communication disruptions due to power failure in the accessory device.

The accessory device may comprise a printer, wherein the at least one transferred parameter value relates to the current printing-fluid level of the printer.

The accessory device may hence as a preventive measure report to other units if it is capable of successfully performing a print-out of a document, thereby avoiding unnecessary resource allocations in the units concerned.

The above objects are obtained according to a second aspect of the present invention by an electric device comprising:

a first transceiver adapted to receive at least one parameter value from an accessory device connected to the electric device via a first wireless communication protocol, said parameter value being related to the operational status of the accessory device, and

a display unit connected to the receiver and adapted to display the at least one parameter value received from the accessory unit.

The electric device is hence able to receive the status information from the accessory device and display the information thereby eliminating the need for a display unit on the accessory device. A user of the electric device will hence be able to determine the current operational status of the accessory device by only using the display of the electric device.

The electric device may be a mobile telecommunication terminal comprising a second transceiver adapted to communicate with a base station via a second wireless communication protocol used for mobile telephony in a mobile telecommunications network.

The electric device will hence be able to transfer audio data, such as speech from a user of the accessory device, to other users in the mobile telecommunications network.

The electric device may communicate via a wireless communication protocol in the form of a short range communication protocol, such as Bluetooth, WLAN, HomeRF or IrDA.

The electric device will then minimize the risk of information tapping by third parties via the wireless communication link and at the same time minimize the interference with other devices outside the range of the short range wireless communication link.

The electric device may comprise a control unit connected to the first transceiver and adapted to transfer one or more commands to the accessory device via the first wireless communication protocol and to determine, using the received parameter value from the accessory device, if the one or more specific commands are to be sent to the accessory device.

The electric device may then be provided with status data regarding the accessory device and determine if it is possible for the accessory device to perform a specific task before assigning the task to the accessory device.

The electric device may comprise a display unit which is adapted to simultaneously display a representation of the at least one parameter value received from the accessory unit and data produced by the electric device.

It is hence possible for a user of the electric device to obtain information regarding the current operational status of the accessory unit without running the risk of missing important information provided by the mobile telecommunication terminal.

The above objects are obtained according to a third aspect of the present invention by a method for transferring operational status data from an accessory device for an electric device to the electric device, said method comprising:

determining at least one parameter value in the accessory device, said parameter value being related to a current operational status of the accessory device,

transferring the parameter value from the accessory device to the electric device via a first wireless communication protocol,

receiving the parameter value in the electric device, and

presenting the received parameter value on a display in the electric device.

The accessory device will hence be able to report to the electric device its current operational status. The electric device may then use its display for displaying the current status of the accessory device, wherein no means for displaying the operational status on the accessory device is needed. The accessory device hence becomes simpler in construction and less expensive to manufacture.

The above objects are obtained according to a fourth aspect of the present invention by an electric device comprising:

a first transceiver adapted to receive at least one parameter value from an accessory device connected to the electric device via a first wireless communication protocol, said parameter value being related to the operational status of the accessory device,

a control unit connected to the first transceiver and adapted to transfer one or more commands to the accessory device via the first wireless communication protocol and to determine, using the received parameter value from the accessory device, if the one or more specific commands are to be sent to the accessory device.

The electric device may then be provided with status data regarding the accessory device and determine if it is possible for the accessory device perform a specific task before assigning the task to the accessory device.

The above objects are obtained according to a fifth aspect of the present invention by a communication system comprising:

an accessory device for an electric devices the accessory device comprising: a control unit adapted to determine at least one parameter value related to the current operational status of the accessory device and for use by the electric device; and a transceiver connected to the control unit and adapted to transfer the at least one parameter value from the control unit in the accessory device to the electric device via a first wireless communication protocol, and an electric device comprising: a first transceiver adapted to receive the at least one parameter value from the accessory device connected to the electric device via a first wireless communication protocol, said parameter value being related to the operational status of the accessory device, a display unit connected to the receiver and adapted to display a representation of the at least one parameter value received from the accessory device.

The accessory device will hence be able to report to the electric device its current operational status. The electric device may then use its display for displaying the current status of the accessory device, wherein no means for displaying the operational status on the accessory device is needed. The accessory device hence becomes simpler in construction and less expensive to manufacture.

### BRIEF DESCRIPTION OF THE DRAWINGS

Further objects, features and advantages of the present invention will become apparent upon consideration of the following detailed description in conjunction with the appended drawings.

FIG. 1 is a schematic illustration of a telecommunication system, in which the present invention may be applied.

FIG. 2 is a schematic block diagram illustrating the accessory device in FIG. 1.

FIG. 3 is a block diagram in more detail of the wireless communication module according to a preferred embodiment of the present invention.

FIG. 4 illustrates an alternative embodiment of the present invention.

FIG. 5 illustrates yet an alternative embodiment of the present invention.

FIG. 6 illustrates yet an alternative embodiment of the present invention.

FIG. 7 illustrates yet an alternative embodiment of the present invention.

### DETAILED DESCRIPTION

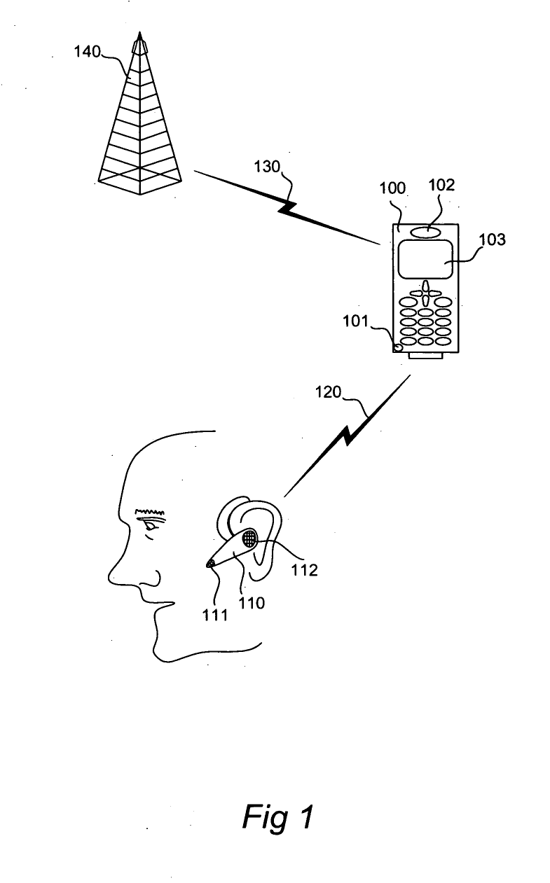

A telecommunication system in which the present invention may be applied will first be described with reference to FIG. 1. Then, the particulars of the operational status transfer technology according to the invention will be described with reference to the remaining FIGs.

FIG. 1 illustrates the communication between a mobile telecommunication terminal 100 and a handsfree unit 110. The mobile telecommunication terminal 100 may be any commercially available device for any known mobile telecommunications system, such as GSM, UMTS, D-AMPS or CDMA2000. The mobile telecommunication terminal 100 comprises a display 103 for presenting information, e.g. regarding the current operational status of the mobile telecommunication terminal 100, to the user of the mobile telecommunication terminal 100. The display may for instance also be used for displaying names and telephone numbers stored in a memory in the mobile telecommunication terminal 100.

The communication between the devices 100, 110 is preferably performed by means of short range wireless technology, such as Bluetooth™, WLAN, HomeRF, IrDA or any other suitable communication protocol. The Bluetooth™ protocol is well suited for short range communication of this kind since the Frequency Hopping Spread Spectrum (FHSS) technology, providing up to 1600 hops/sec amongst 79 channels which are spaced at 1 MHz separation, provides high security against tapping of information by third parties and reduction of interference and fading. Moreover, the different transmission powers supported by the Bluetooth™ standard (0 dBm-10 m, 4 dBm-20 m and 20 dBm-100 m) makes it easy to customize the communication link for every need.

A microphone 111 in the handsfree unit 110 picks up audio data (speech) from the user of the handsfree unit 110. As will be disclosed in more detail below, the audio data is then processed in the handsfree unit 110 and transferred to the mobile telecommunication terminal 100 via the wireless communication link 120. In the mobile telecommunication terminal 100 the audio data is further processed according to techniques known per se depending on which type of mobile telecommunication network the mobile telecommunication terminal is operating in. The speech of the user is thereafter transferred to another user via a second wireless communication link 130. The second communication link 130 is preferably established between the mobile telecommunication terminal 100 and a base station 140 used for mobile telephony in a mobile telecommunications network. Correspondingly, audio data received in the mobile telecommunication terminal 100 via the second communication link 130 is processed in the mobile telecommunication terminal 100 and then transferred to the handsfree unit 110 via the first communication link 120. The processed audio data is then played back to the user of the handsfree unit 110 by means of an earphone 112 arranged in the handsfree unit 110. A microphone 101 arranged in the mobile telecommunication terminal 100 for picking up audio data from the user is preferably disabled when the presence of the handsfree unit 110 has been detected by the mobile telecommunication terminal 100. A loudspeaker 102 arranged in the mobile telecommunication terminal 100 for play back of audio data to the user is correspondingly disabled when the presence of the handsfree unit 110 is detected by the mobile telecommunication terminal 100.

Besides transferring audio data back and forth between the mobile telecommunication terminal 100 and the handsfree unit 110, the wireless communication link 120 is also used for transferring other data from the handsfree unit 110, which data relate to the current operational status of the handsfree unit 110. The status data may relate to the current power level of the batteries providing power to the handsfree unit 110, the current volume settings in the handsfree unit (i.e. the amplification of picked-up and/or played-back audio data), the current signal strength of the first communication link 120 detected by the handsfree unit 110, the available memory space in a memory internal to the handsfree unit 110, etc. It is appreciated in this context that any kind of status data may be transferred from the handsfree unit 110 to the mobile telecommunication terminal 100 via the first wireless communication link 120.

In a preferred embodiment the first wireless communication link 120 is established using Bluetooth™ technology. As mentioned above, the Bluetooth™ standard offers many different configuration alternatives making it possible to optimize the performance of the first wireless communication link 120 for a specific application. For example, the Bluetooth™ standard offers three simultaneous synchronous (SCO—Synchronous Connection-Oriented Link) voice channels in each direction of the first wireless communication link 120 by the provision of circuit switching with a slot reservation at fixed intervals. The Bluetooth™ standard also offers asynchronous (ACL—Asynchronous Connection-Less Link) data channels by the provision of packet switching utilizing a polling access scheme. In a preferred embodiment of the present invention a Bluetooth™ configuration with combined data-voice SCO packets is utilized. This configuration provides 64 kb/sec voice and 64 kb/sec data in each direction of the first wireless communication link 120, wherein both audio data and status data may be independently transferred from the handsfree unit 110 to the mobile telecommunication terminal 100. The status data received in the mobile telecommunication terminal 100 is then preferably presented on the display 103 in the mobile telecommunication terminal 100.

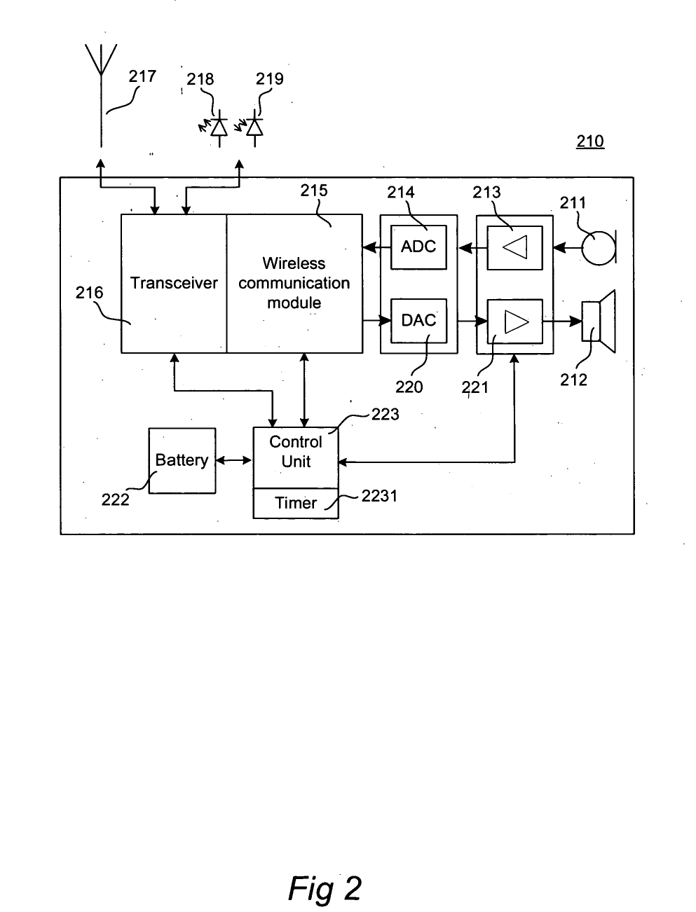

FIG. 2 is a general block diagram of the functional blocks of the handsfree unit 210 according to a preferred embodiment of the present invention. The handsfree unit 210 comprises a microphone 211 for converting audio data in the form of speech signals (pressure variations) into audio data in the form of analog electrical signals. The analog signals are fed to an amplifier/attenuator 213 for providing a signal that maximizes the signal-to-noise ratio in the subsequent signal processing. The analog signals are then converted to digital form by means of an ADC 214 (Analog to Digital Converter). After being converted into digital form, the audio data is fed to a wireless communication module 215 which formats the audio data according to any suitable communication standard, such as Bluetooth™, WLAN, HomeRF, or IrDA, in order to provide a communication link between the handsfree unit 210 and the mobile telecommunication terminal 100. The following disclosure will focus on the use of Bluetooth™ for establishing a wireless communication link 120 between the handsfree unit 210 and the mobile telecommunication terminal 100. It is, however, emphasized that any other suitable protocol may be used within the scope of the present invention. The wireless communication module 215 comprises a transceiver 216 which converts the electric audio data signals into radio waves via an antenna 217, or into light signals via e.g. a light emitting diode 218 depending on the protocol used in the wireless communication module 215.

Correspondingly, the transceiver 216 receives audio data via the antenna 217 or a photo diode 219 and converts the data into electrical signals for processing in the wireless communication module 215. After decoding the received data in accordance with the desired protocol, the audio data are converted from digital form to analog form by means of a DAC 220 (Digital to Analog Converter). The analog audio data is then fed to an amplifier/attenuator 221 for establishing a signal amplitude suitable for reproduction in an earphone 212.

Moreover, the handsfree unit 210 also comprises a power source, such as a battery 222, for providing power to the various electronic blocks in the handsfree unit 210.

In addition to the processing and transmission of audio signals described above, the handsfree unit 210 also provides additional signal processing and transmission capabilities. More specifically, a control unit 223 is connected to the amplifiers/attenuators 213, 221, the wireless communication module 215, the transceiver 216 and the battery 222 for collecting data from each functional block regarding their operational status. In a preferred embodiment the control unit 223 is able to set the amplification/attenuation of the amplifiers/attenuators 213, 221 as well as read out their current amplification settings. The attenuators/amplifiers are preferably digitally controlled, e.g. by means of a digital attenuator connected to a linear amplifier or by any commercially available digital amplifier/attenuator such as the LM4832 from National Semiconductor, 2900 Semiconductor Drive, P.O. Box 58090, Santa Clara, Calif., USA 95052-8090.

Furthermore, as will be disclosed in more detail below, the control unit 223 is connected to the wireless communication module 215 for controlling the operation of the module and for receiving data regarding the operational status of the module. The controller 223 is also connected to the transceiver 216 for being able to read out in a manner known per se e.g. the current signal strength of the wireless communication link 120 detected by the transceiver 216. Additionally, the control unit 223 is connected to the battery 222 for being able to determine the actual power level of the battery 222. The measuring of the power level of the battery may be performed in many different ways depending on the specific battery technology used for manufacturing the battery. For example, the control unit 223 may, via an ADC (not shown), measure the voltage level over the poles of the battery 222 at a given current drain from the battery 222. Other techniques, such as discharge time measurements or chemical measurements of the compounds in the battery 222 for determining the actual power level in the battery 222 is equally possible within the scope of the invention.

At a given time interval or upon request from the mobile telecommunication terminal 100, the control unit 223 collects operational status data from one or more of the functional blocks in the handsfree unit 210 as disclosed above and instructs the transceiver 216 via the wireless communication module 215 to transfer operational status data, to the mobile telecommunication terminal 100, relating to the current operation of one or more of the modules in the handsfree unit 210.

For the time-bound transmission of status data the control unit 223 comprises a software or hardware timer 2231 for being able to determine the lapse of a specified time interval. At the end of the time interval the timer 2231 generates an interrupt in the control unit 223 which initiates the collection and transmission of status data to the mobile telecommunication terminal 100. Alternatively, the mobile telecommunication terminal 100 instructs the handsfree unit 210 via one of the 64 kb/sec data channels in the wireless communication link 120 to collect and transmit status data relating to the operational status of the functional blocks in the handsfree unit 210.

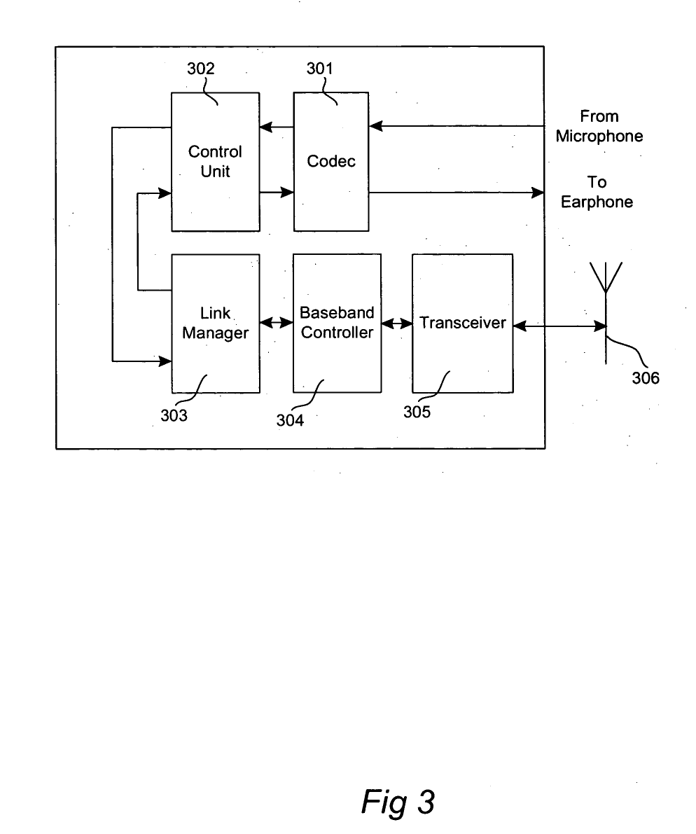

FIG. 3 is a more detailed block diagram of a preferred embodiment of the wireless communication module 215 and the transceiver 216 according to the present invention.

The signals from the microphone are received in a CVSD (Continuous Variable Slope Delta) or PCM (Pulse Coded Modulation) codec 301 for encoding the signals according to the Bluetooth™ specification.

In this embodiment a control unit 302 is integral with the wireless communication module 215. It is, however, emphasized in this context that the control unit 302 as well may be a separate circuit which is connected to the wireless communication module 21p. In this embodiment the control unit 302 controls the behavior of and collects status data from the other circuitry in the handsfree unit 210 as disclosed above. Additionally, the control unit 302 implements the L2CAP (Logical Link Control and Adaptation Protocol) according to the Bluetooth™ standard. In implementing the L2CAP, the control unit 302 performs four major functions: managing the creation and termination of separate audio and/or data channels for each desired connection between the handsfree unit 210 and the mobile telecommunication terminal 100, imposing and enforcing QoS (Quality of Service) requirements, i.e. specifying a guaranteed throughput level of data according to the Bluetooth™ standard, formatting data that is transferred to/from the functional blocks in the handsfree unit 210 from/to the mobile telecommunication-terminal 100, and multiplexing data from different sources in the handsfree unit 210 in order to permit multiple parallel connections over a single common radio interface.

The control unit 302 is connected to a link manager 303 which controls the physical link resources in the system and performs all link creation, management, and termination operations. The link manager 303 receives requests from the control unit 302 via the L2CAP to establish outbound links and confirms successful completion of data transfers. Moreover, the link manager 303 also receives and processes inbound link control operations from the mobile telecommunication terminal 100. The link manager 303 is moreover responsible for closing channels that does not conform with the L2CAP.

The link manager 303 is connected to a baseband controller 304 which performs all necessary data processing of the audio and status data received from the control unit 302 immediately before and after data transmission via the wireless communication link 120. The baseband controller 304 also performs additional network-specific tasks which in the case of Bluetooth™ include inquire scanning, page scanning, as well as hold, sniff, park and standby state management.

Finally a transceiver 305 converts the audio and status data from the baseband controller 304 into a format suitable for transmission to the mobile telecommunication terminal 100. Preferably the transceiver 305 converts the data into radio waves which are transmitted via an antenna 306 according to the Bluetooth™ standard, i.e. the signal is modulated using GFSK (Gaussian Frequency Shift Keying) with a modulation index between 0.28 and 0.35 in a frequency range of 0.2400-2483.5 MHz.

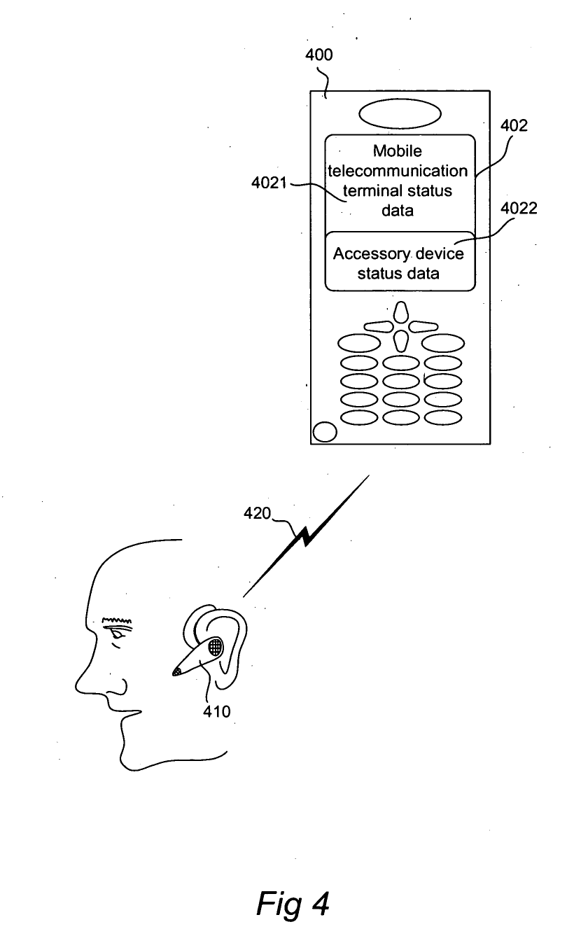

FIG. 4 illustrates another embodiment of a mobile telecommunication terminal 400 according to the present invention. According to this embodiment the mobile telecommunication terminal 400 receives audio and status data from the handsfree unit 410 via the wireless communication link 420 in the same way as disclosed above. However, the mobile telecommunication terminal 100 comprises a display unit 402 which is adapted not only to show data originating from the mobile telecommunication terminal 400 itself, but rather data from both the mobile telecommunication terminal 400 and the handsfree unit 410. In doing so the display unit is divided into a first section 4021 and a second section 4022, where the first display section 4021 is used for presenting data, such as status data, originating from the mobile telecommunication terminal 400, and the second display section 4022 is used for displaying status data originating from the handsfree unit 410.

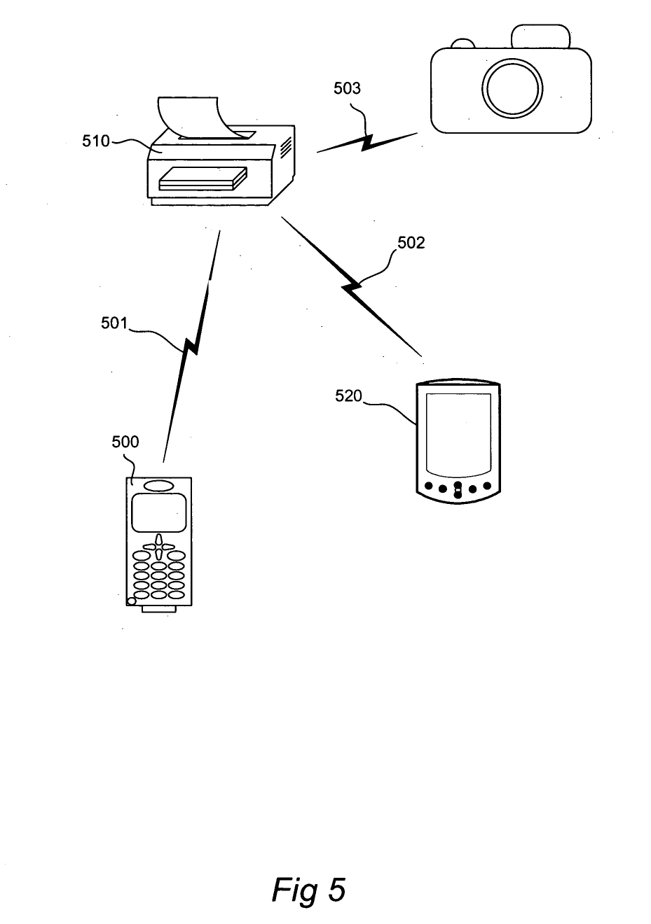

FIG. 5 illustrates an alternative embodiment of the present invention. In this embodiment an accessory device in the form of e.g. a printer 510 communicates with e.g. a mobile telecommunication terminal 500 in the form of a mobile telephone, a camera 530 and a personal digital assistant (PDA) 520. By way of example, the Bluetooth™ standard provides the possibility to connect up to 8 units in a pico-net, wherein one master unit communicates with 7 slave units.

In this embodiment the printer 510 provides status information to the mobile telecommunication terminal 500, the camera 530 and the PDA 520 via the wireless communication links 501, 502 and 503 respectively. More specifically, status data regarding the current printing-fluid level, i.e. ink, powder or the like, in the printer is collected by a control unit in the printer and transferred to the other devices in the vicinity of the printer 510. By this arrangement, the mobile telecommunication terminal 500, the camera 530, and the PDA 520 are updated with the current operational status of the printer 510 with regard to the ink-level, and is hence able to determine if it is possible to successfully print a document, e.g. an address book or a picture, on the printer 510 before taking the steps of trying to assign the printing operation to the printer 510.

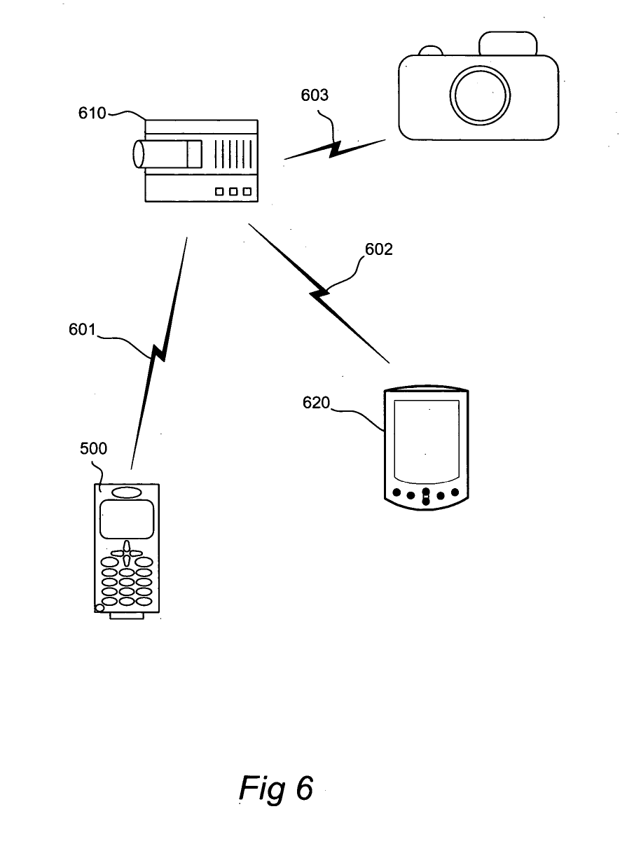

FIG. 6 illustrates yet an alternative embodiment of the present invention. In this embodiment an accessory device in the form of e.g. a projector 610 communicates with e.g. a mobile telecommunication terminal 600 in the form of a mobile telephone, a camera 630 and a personal digital assistant (PDA) 620.

In this embodiment the projector 610 provides status information to the mobile telecommunication terminal 600, the camera 630 and the PDA 620 via the wireless communication links 601, 602 and 603 respectively. More specifically, status data regarding the current memory utilization, i.e. how many images, slides, documents or video sequences may the projector store for subsequent display on a screen (e.g. a TV-screen), in the projector is collected by a control unit in the projector and transferred to the other devices in the vicinity of the projector 610. By this arrangement, the mobile telecommunication terminal 600, the camera 630, and the PDA 620 are updated with the current operational status of the projector 610 with regard to the memory utilization, and is hence able to determine if it is possible to successfully display an image or video sequence by means of the projector 610 before taking the steps of trying to assign the displaying operation to the projector 610.

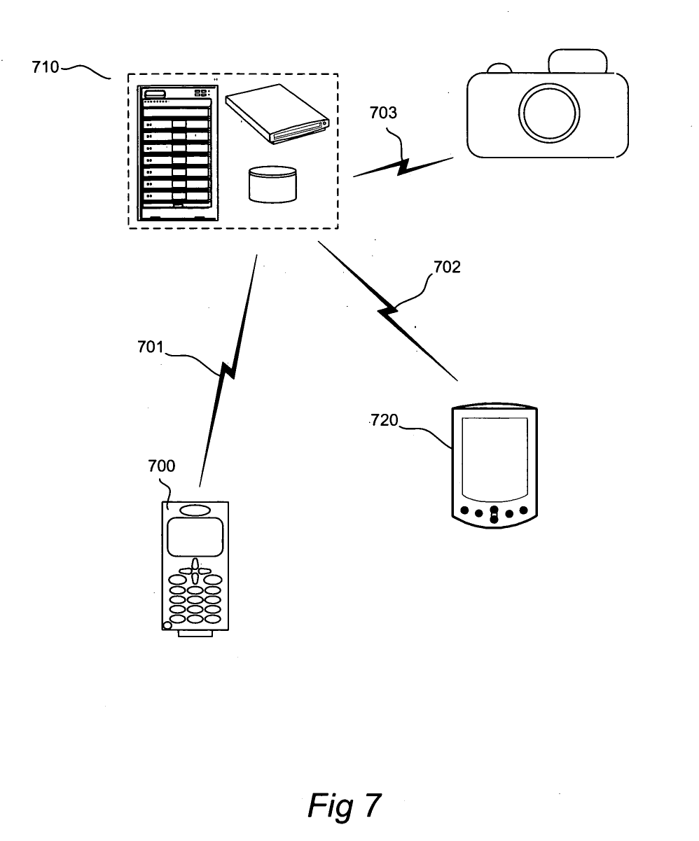

Similarly, FIG. 7 illustrates yet an alternative embodiment of the present invention. In this embodiment an accessory device in the form of an external data storage device 710 communicates with e.g. a mobile telecommunication terminal 700 in the form of a mobile telephone, a camera 730 and a personal digital assistant (PDA) 720. Status data regarding the current memory utilization, i.e. the actual free amount of storage space, in the data storage device 710 is collected by a control unit in the data storage device 710 and transferred to the other devices in the vicinity of the data storage device 710. By this arrangement, the mobile telecommunication terminal 700, the camera 730, and the PDA 720 are updated with the current operational status of the projector 710 with regard to the memory utilization, and is hence able to determine if it is possible to successfully display an image by means of the data storage device 710 before taking the steps of trying to assign the storage operation to the storage device 710.

While the present invention has been particularly shown and described with reference to specific embodiments thereof, it will be understood by those skilled in the art that various changes in form and detail may be made thereto, and that other embodiments of the present invention beyond embodiments specifically described herein may be made or practiced without departing from the spirit and scope of the present invention as limited solely by the appended claims.

1. An accessory device for an electric device, the accessory device comprising:
a control unit adapted to determine at least one parameter value related to a current operational status of the accessory device and for use by the electric device; and
a transceiver connected to the control unit and adapted to transfer the at least one parameter value from the control unit in the accessory device to the electric device via a first wireless communication protocol.

2. The accessory device according to claim 1, wherein the wireless communication protocol is a short range communication protocol, such as Bluetooth, WLAN, HomeRF or IrDA.

3. The accessory device according to claim 1 comprising a battery for providing power to the accessory device, wherein the at least one transferred parameter value is related to a current power level of the battery.

4. The accessory device according to claim 1 comprising a printer, wherein the at least one transferred parameter value relates to a current printing-fluid level of the printer.

5. The accessory device according to claim 1 comprising a memory, wherein the at least one transferred parameter value relates to a current utilization of the memory.

6. The accessory device according to claim 5, wherein the memory is arranged in a projector and the at least one transferred parameter value relates to a current memory utilization in the projector.

7. An electric device comprising:
a first transceiver adapted to receive at least one parameter value from an accessory device connected to the electric device via a first wireless communication protocol, said parameter value being related to a current operational status of the accessory device, and
a display unit connected to the receiver and adapted to display a representation of the at least one parameter value received from the accessory unit.

8. The electric device according to claim 7, wherein the electric device is a mobile telecommunication terminal comprising a second transceiver adapted to communicate with a base station via a second wireless communication protocol used for mobile telephony in a mobile telecommunications network.

9. The electric device according to claim 7, embodied as a mobile telephone for a mobile telecommunications system, such as GSM, US-TDMA, cdmaOne PCS, PDC or UMTS.

10. The electric device according to claim 7, embodied as a personal digital assistant (PDA).

11. The electric device according to claim 7, wherein the first wireless communication protocol is a short range communication protocol, such as Bluetooth, WLAN, HomeRF or IrDA.

12. The electric device according to claim 7, comprising:
a control unit connected to the first transceiver and adapted to transfer one or more commands to the accessory device via the first wireless communication protocol and to determine, using the received parameter value from the accessory device, if the one or more specific commands are to be sent to the accessory device.

13. The electric device according to claim 7, wherein the display unit is adapted to simultaneously display a representation of the at least one parameter value received from the accessory unit and data produced by the electric device.

14. A method for transferring operational status data from an accessory device for an electric device to the electric device, said method comprising:
determining at least one parameter value in the accessory device, said parameter value being related to a current operational status of the accessory device,
transferring the parameter value from the accessory device to the electric device via a first wireless communication protocol,
receiving the parameter value in the electric device, and
presenting a representation of the received parameter value on a display in the electric device.

15. The method according to claim 14, wherein the electric device is a mobile telecommunication terminal comprising a second transceiver adapted to communicate with a base station via a second wireless communication protocol used for mobile telephony in a mobile telecommunications network.

16. The method according to claim 14, wherein the first wireless communication protocol is a short range communication protocol, such as Bluetooth, WLAN, HomeRF or IrDA.

17. The method according to claim 14, comprising:
determining if one or more commands are to be transferred from the electric device to the accessory device via the first wireless communication protocol based on the received parameter value from the accessory device.

18. The method according to claim 14, comprising:
simultaneously displaying, on the display, a representation of the at least one parameter value received from the accessory unit and data produced by the electric device.

19. An electric device comprising:
a first transceiver adapted to receive at least one parameter value from an accessory device connected to the electric device via a first wireless communication protocol, said parameter value being related to a current operational status of the accessory device,
a control unit connected to the first transceiver and adapted to transfer one or more commands to the accessory device via the first wireless communication protocol and to determine, using the received parameter value from the accessory device, if the one or more specific commands are to be sent to the accessory device.

20. The electric device according to claim 19, wherein the electric device is a mobile telecommunication terminal comprising a second transceiver adapted to communicate with a base station via a second wireless communication protocol used for mobile telephony in a mobile telecommunications network.

21. The electric device according to claim 19, wherein the first wireless communication protocol is a short range communication protocol, such as Bluetooth, WLAN, HomeRF or IrDA.

22. A communication system comprising:
an accessory device for an electric device, the accessory device comprising: a control unit adapted to determine at least one parameter value related to the current operational status of the accessory device and for use by the electric device; and a transceiver connected to the control unit and adapted to transfer the at least one parameter value from the control unit in the accessory device to the electric device via a first wireless communication protocol, and
an electric device comprising: a first transceiver adapted to receive the at least one parameter value from the accessory device connected to the electric device via a first wireless communication protocol; and a display unit connected to the receiver and adapted to display a representation of the at least one parameter value received from the accessory device.

23. The communication system according to claim 22, wherein the electric device is a mobile telecommunication terminal comprising a second transceiver adapted to communicate with a base station via a second wireless communication protocol used for mobile telephony in a mobile telecommunications network.

24. A communication system comprising:
an accessory device for an electric device, the accessory device comprising: a control unit adapted to determine at least one parameter value related to the current operational status of the accessory device and for use by the electric device; and a transceiver connected to the control unit and adapted to transfer the at least one parameter value from the control unit in the accessory device to the electric device via a first wireless communication protocol, and
an electric device comprising: a first transceiver adapted to receive at least one parameter value from the accessory device connected to the electric device via a first wireless communication protocol, said parameter value being related to a current operational status of the accessory device; and a control unit connected to the first transceiver and adapted to transfer one or more commands to the accessory device via the first wireless communication protocol and to determine, using the received parameter value from the accessory device, if the one or more specific commands are to be sent to the accessory device.
